(19) United States
(12) Patent Application Publication
(10) Pub. No.: US 2025/0207556 A1
(43) Pub. Date: Jun. 26, 2025

(54) MANGROVE INSPIRED STRUCTURES FOR ENERGY HARVESTING

(71) Applicants: FLORIDA ATLANTIC UNVERSITY BOARD OF TRUSTEES, Boca Raton, FL (US); PURDUE RESEARCH FOUNDATION, West Lafayette, IN (US)

(72) Inventors: Oscar CURET, Boca Raton, FL (US); Luciano CASTILLO, West Lafayette, IN (US); Amirkhosro KAZEMI, Hollywood, FL (US)

(21) Appl. No.: 18/847,433

(22) PCT Filed: Jan. 12, 2023
(86) PCT No.: PCT/US2023/010668

§ 371 Date: Sep. 16, 2024

Related U.S. Application Data
(60) Provisional application No. 63/320,867, filed on Mar. 17, 2022.

(51) Int. Cl. F03B 17/06

(52) U.S. Cl. CPC F03B 17/06; F05B 2250/231

(57) ABSTRACT

Apparatus and methods of harvesting energy are disclosed, the apparatus including: a) at least one cylindrical member; b) a mounting member; c) a securing member, wherein the securing member flexibly couples the cylindrical member to the mounting member; and d) a mechanical-to-electrical energy conversion member. Methods include: a) flexibly coupling at least one cylindrical member to a mounting member with a securing member; b) coupling a mechanical-to-electrical energy conversion member to the mounting member; c) placing the apparatus of the invention in a body of water with water current of a strength that is able to move the cylindrical member when the cylindrical member comes into contact with the water current; and d) generating electricity with the mechanical-to-electrical energy conversion member, wherein the movement of the cylindrical member in the water current provides necessary mechanical energy for the mechanical-to-electrical energy conversion member to generate electricity.

### STATEMENT REGARDING FEDERALLY SPONSORED RESEARCH OR DEVELOPMENT

Aspects of this invention were made with government support under grant number 1950123 awarded by the National Science Foundation. The government has certain rights in the invention.

### BACKGROUND OF THE INVENTION

### 1. Field of Invention

This invention relates to systems and methods of harvesting energy from tidal flows while enhancing coastal protection from erosion.

### 2. Description of Related Art

Industrial innovations have brought environmental consequences, such as climate change and the need for renewable energy resources. In the past 100 years, sea levels have risen approximately seven inches [1] and the severity of climate-induced weather patters has increased, leading to increased precipitation, cyclone activity, and flooding [2]. As a result, land erosion has become a persistent problem world-wide [3], and there is a need for renewable energy resources to reduce the effect of pollutants produced in current energy-harvesting methods. Hydropower, or hydroelectric power, is a renewable energy source generated by waterflow, such as a dam or other structure that alters the water's movement [4].

Tidal and river flows have previously been utilized for energy production. For example, U.S. Pat. No. 10,982,645 B2 (Han) discloses a river and turbine used for power control. Han discloses a turbine including a Hummingbird control, a control motor, and a generator among other components. These components are mounted on a floating platform for delivery of constant power at constant frequency given sufficient input from a waterwheel harnessing module driven by river current flow in at least one direction. In certain embodiments, Han discloses a moveable hatch permitting the waterwheel to turn in the same rotational direction regardless of the direction of water flow.

U.S. Patent No. 8,643,206 B2 (Ekert) discloses a water-based renewable energy system including a water wheel/weir assembly to provide pumping power for the system. The system includes a lower and higher reservoir, where water is pumped to the higher reservoir, released to a generator in a lower reservoir, and the generator uses the water flow from higher to lower elevation to generate electricity.

However, turbines such as that disclosed in Han may often be large and take up significant space in a body of water, displacing or disrupting wildlife in the area. Examples of hydropower systems such as that disclosed in Eckert also take up considerable space and include floating assemblies spanning a large portion of the water's surface. While progress has been made in the hydroelectric field, there is a need for a way to harness energy also mitigates other climate-induced issues such as land erosion.

Mangrove roots are resilient coastal structures found in sub-tropical and tropical regions. Red Mangrove trees have prop root systems, wherein roots extend from the trunk of the tree and even mangrove branches, enhancing stability and making it possible for mangroves to thrive in soft sediments along shorelines or other coastal areas. Red Mangroves additionally possess shallow, wide-spread root systems that provide additional stability against eroding forces, such as wind or tides.

Studies have shown that mangrove trees may be effective at blunting tidal forces and have unique hydrodynamic interactions with the surrounding water. [4-5] Mangrove trees are a natural interface in tropical and subtropical regions between land and coastal zones, forming a dense network of prop roots that make them resilient in this environment. The interaction of mangroves with tidal and river flows is fundamental to the preservation of estuaries and shorelines by providing a wide range of ecological ecosystem functions such as reducing coastal erosion, promoting biodiversity, and removal of nitrogen, phosphorus as well as carbon dioxide sequestrations. In particular, mitigation of erosion is highly influenced by the interaction of the flow and the intricate prop roots. The roots enhance the mangrove drag, and in tidal currents flows, the frictional effect from the drag can cause the currents to rotate and interact with the root patch. The trunk, branches, leaves, and roots of the mangrove act as an obstruction to the water flow, adding a biological dimension to the complex interactions between hydrodynamics and sediment movement in coastal area. The mangrove and hydrodynamic interaction affect the flow structure, turbulence, and waves with subsequent impact on the onset of sediment transport. However, mangroves are only able to grow in limited environments, and may not be naturally occurring in specific locations.

Thus, there is a need for systems and methods to harvest energy using water current while preventing coastal erosion that can avoid disruption to wildlife and be easily installed in a variety of coastal areas.

All references cited herein are incorporated herein by reference in their entireties.

### BRIEF SUMMARY OF THE INVENTION

A first aspect of the invention is an apparatus for harvesting energy, the apparatus comprising: a) at least one cylindrical member; b) a mounting member; c) a securing member, wherein the securing member flexibly couples the cylindrical member to the mounting member; and d) a mechanical-to-electrical energy conversion member.

In certain examples, wherein a plurality of the at least one cylindrical members are coupled to one another in a patch formation.

In certain examples, the mounting member comprises a corrosion resistant material.

In certain examples, the corrosion resistant material is selected from the group consisting of stainless steel, aluminum, copper, bronze, brass, galvanized steel, copper steel, alloy steel, polypropylene, polytetrafluorethylene (PTFE), polyvinyl chloride (PVC), and high-density polyethylene.

In certain examples, the securing member is selected from the group consisting of elastic, a linear spring and a torsional spring.

In certain examples, the mechanical-to-electrical energy conversion member is selected from the group consisting of an electric generator, piezo-electric material, pelton wheel, and a hydraulic pump.

In certain examples, the mechanical-to-electrical energy conversion member includes magnets.

In certain examples, the mechanical-to-electrical energy conversion member is coupled to the mounting member.

In certain examples, the apparatus further includes at least one actuator.

In certain examples, the at least one actuator is selected from the group consisting of an angular actuator, linear actuator, or rotational actuator.

In certain examples, the apparatus further includes a hydraulic accumulator.

In certain examples, the apparatus further includes an energy transfer system coupled to the mechanical-to-electrical energy conversion member.

In certain examples, the energy transfer system comprises a power line.

In certain examples, a transmitter and a receiver, wherein the transmitter is coupled to the mounting member and the transmitter is located in a remote location.

A second aspect of the invention is a system of harvesting energy using the apparatus of the invention, the system comprising: a) flexibly coupling at least one cylindrical member to a mounting member with a securing member; b) coupling a mechanical-to-electrical energy conversion member to the mounting member; c) placing the apparatus of the invention in a body of water with water current of a strength that is able to move the cylindrical member when the cylindrical member comes into contact with the water current; and d) generating electricity with the mechanical-to-electrical energy conversion member, wherein the movement of the cylindrical member in the water current provides necessary mechanical energy for the mechanical-to-electrical energy conversion member to generate electricity.

In certain examples, the system further includes using a plurality of cylindrical members in a patch formation.

In certain examples, the system further includes coupling at least one actuator to the apparatus, wherein a) the actuator is coupled to the cylindrical member and the mechanical-to-electrical energy conversion member, b) the actuator moves in response to the movement of the cylindrical member, and c) the actuator provides mechanical energy necessary to power the mechanical-to-electrical energy conversion member.

In certain examples, the system further includes coupling an energy transfer system to the mechanical-to-electrical energy conversion member, wherein electricity generated from the mechanical-to-electrical energy conversion member is carried from the mechanical-to-electrical energy conversion member to a power usage destination.

In certain examples, the system further includes transmitting water flow and electricity data from a transmitter coupled to the mounting member to a receiver located in a remote location.

### BRIEF DESCRIPTION OF SEVERAL VIEWS OF THE DRAWINGS

The invention will be described in conjunction with the following drawings:

FIG. 1(a) is a photograph showing the prop roots of red mangrove trees.

FIG. 1(b) shows a schematic of mangrove roots.

FIG. 1(c) shows the flow visualization behind mangrove root models of the invention.

FIG. 2 shows an example of the invention tested in a laboratory setting simulating the flow dynamics when the invention is used in a body of water.

FIG. 3 shows an example of the invention in a “patch” formation, wherein a plurality of cylindrical members are coupled to one another at a mounting member.

FIG. 4 shows another example of the invention using an exemplary single cylindrical member with a 4 inch diameter.

FIG. 5(a) shows an experimental setup of the cylindrical member mounted in the towing carrier.

FIG. 5(b) shows a photograph of the camera used in the experimental setup.

FIG. 5(c) shows a graph of amplitude in cm vs. time in seconds for a carrier speed of 0.35 m/s.

FIG. 6 shows a series of graphs showing results of testing a single cylindrical member embodiment of the invention, wherein the graphs show amplitude in centimeters versus towing speed of the carrier in m/s, frequency in Hz versus towing speed in m/s, and power in W versus towing speed in m/s.

FIG. 7(a) shows an exemplary mangrove inspired system for energy harvesting with a hydraulic power conversion when the angular actuator is in a still state

FIG. 7(b) shows the same exemplary system when the angular actuator is oscillating in response to water movement.

FIG. 8 shows a free-body diagram of an exemplary single-cylindrical member model of the invention and the forces exerted upon the cylindrical member while in use and oscillating.

FIG. 9(a) shows an isometric view of a schematic of a single cylindrical member embodiment of the invention.

FIG. 9(b) shows a side view of a schematic of the same single cylindrical member embodiment of the invention shown in FIG. 9(a).

FIG. 10 shows another free-body diagram of an exemplary single-cylindrical member embodiment of the invention.

FIG. 11 shows a graph of the amplitude of oscillation for a single cylindrical member embodiment of the invention in mm versus flow velocity in m/s.

FIG. 12 shows a flow chart schematic of power generation using a plurality of the exemplary mangrove-inspired tidal energy generators.

FIG. 13 shows a graph of amplitude of the wavelength of power generated by an exemplary embodiment of the invention versus time in seconds.

### DETAILED DESCRIPTION OF PREFERRED EMBODIMENTS OF THE INVENTION

Coastal areas subjected to the constant attack of waves or tidal forces may experience severe erosion. The system and method of the invention uses mangrove-inspired ocean structures to mitigate and prevent soil erosion.

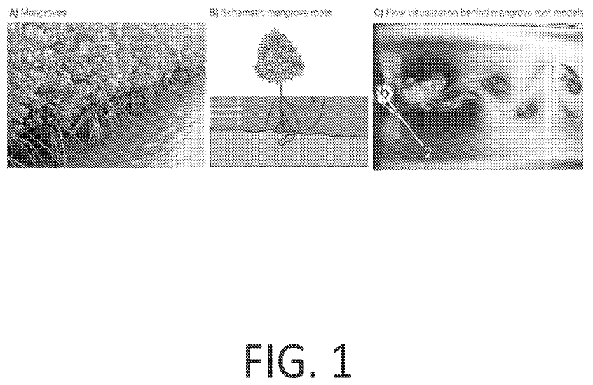

Referring to the Figures, the interaction of mangroves with tidal and river flows is fundamental to the preservation of estuaries and shorelines by providing a wide range of ecological ecosystem functions such as reducing coastal erosion, promoting biodiversity, and removal of nitrogen, phosphorus, and carbon dioxide sequestrations. In particular, mitigation of erosion is highly influenced by the interaction of the water flow and the intricate prop roots. In an example showing the effectiveness of natural root structures, as shown in the photograph of FIG. 1(a), red mangrove (Rhizophora mangle) prop roots protrude from a shoreline, extend from the tree trunk, and form a radial, circular patch or large-scale mangrove forests. The roots enhance the mangrove drag, and in tidal currents flows, the frictional effect due to the drag can cause the currents to rotate and interact with the root patch. FIG. 1(b) shows a schematic of mangrove roots. The roots generate small-scale turbulence through the developments of vortex shedding and eddy formation. trunk, branches, leaves, and roots of the mangrove act as an obstruction to the water flow adding a biological dimension to the complex interactions between hydrodynamics and sediment movement in coastal area. This mangrove and hydrodynamic interaction affect the flow structure, turbulence, and waves with subsequent impact on the onset of sediment transport. FIG. 1(c) shows the flow visualization behind mangrove root models, wherein water flow is shown around nine cylindrical members 2 positioned in a circular arrangement, with eight cylindrical members positioned around a central cylindrical member.

In certain examples of the apparatus of the invention, the apparatus is composed of one or multiple cylindrical members 2 submerged underwater and hinged at the top with a securing member including but not limited to elastic material, a linear spring, and a torsional spring. In presence of range of flow speeds the device will oscillate perpendicular to the flow. The region of oscillation and power output could be varied with the stiffness of the system. In other examples, an electric generator, piezo-electric material, hydraulic pump or other device for mechanical/electrical conversion is used to convert the mechanical motion to electricity. In certain examples of the invention, the cylindrical member has a diameter of 0.5 to 4.5 inches. However, in other examples, the cylindrical member are of a larger size, such as 12 inches or multiple feet. Examples of the invention were tested at flow speeds ranging from 0 to 2.2 mph. However, the invention is designed to be used at even greater flow speeds equivalent to that found in naturally occurring water currents. The apparatus of the invention is used in bodies of water with water current including streams, rivers, lakes, and oceans.

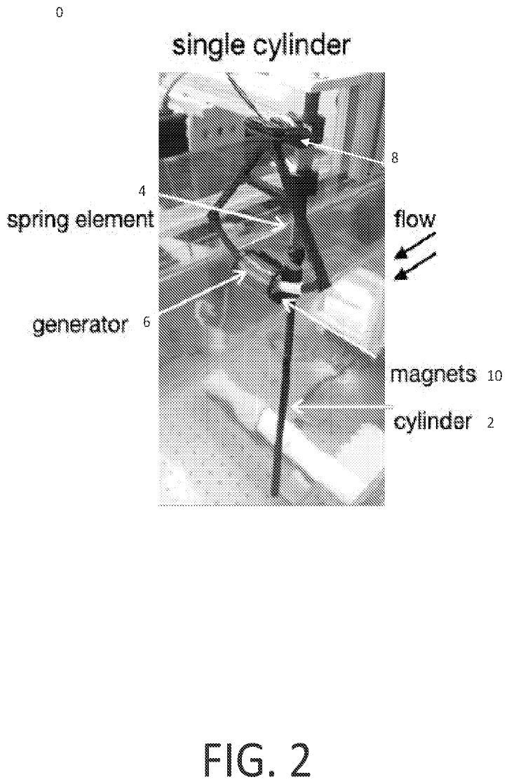

FIG. 2 shows an example of the invention 0 tested in a laboratory setting simulating the flow dynamics when the invention is used in a body of water, such as coastal waters, rivers, or streams. This exemplary prototype includes a single cylindrical member 2. The exemplary apparatus 0 shown in FIG. 2 includes a single cylindrical member 2, a mounting member 8 flexibly coupled to the cylindrical member 2, a securing member 4 to flexibly couple the cylindrical member 2 to the mounting member 8, and a mechanical-to-electrical energy conversion member 6. In this example, the securing member 4 is a spring, and the mechanical-to-electrical energy conversion member 6 is a copper wire coil and magnet 10 combination used to function as a generator. When the cylindrical member moves in water in response to current, the movement of the cylindrical member 2 acts as an angular actuator, triggering mechanical energy necessary to power the generator. The generator is then able to generate electricity from the input of mechanical energy. In additional examples of the apparatus, the securing member is elastic. In additional examples, the mechanical-to-electrical energy conversion member 6 is selected from the group including an electric generator, other piezo-electric material, wind turbine, pelton wheel, and a hydraulic pump.

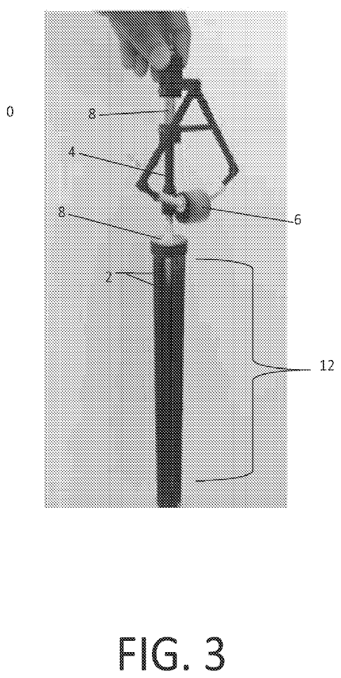

FIG. 3 shows an example of the invention in a “patch” formation 12, wherein a plurality of cylindrical members 2 are coupled to one another at a mounting member 8. In certain examples, a plurality of mounting members 8 is used to attach the components of the apparatus 0. In preferred examples, the mounting member 8 is made of a material resistant to water corrosion over time. In certain examples, a mounting member 8 is made of a material including but not limited to stainless steel, aluminum, copper, bronze, brass, galvanized steel, copper steel, alloy steel, polypropylene, polytetrafluorethylene (PTFE), polyvinyl chloride (PVC), and high-density polyethylene. The exemplary apparatus shown in FIG. 3 also includes a securing member 4 to flexibly couple the cylindrical member 2 to the mounting member 8, and a mechanical-to-electrical energy conversion member 6. In this example, the securing member 4 (FIG. 2) is a steel plate that serves as a torsional spring, and the mechanical-to-electrical energy conversion member 6 is a copper wire coil and magnet 10 combination used to function as a generator of electricity.

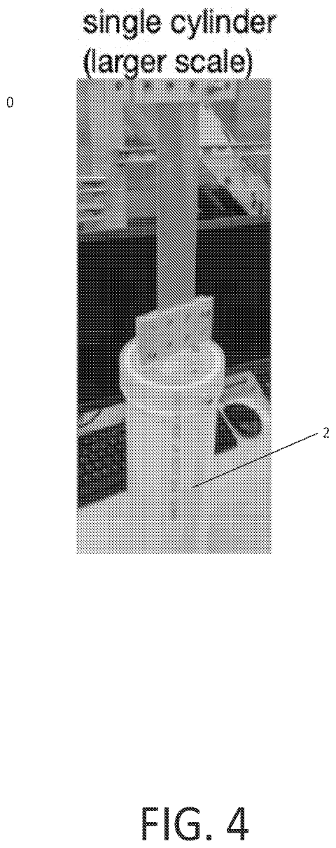

FIG. 4 shows another example of the invention using a single cylindrical member 2 with a 4-inch diameter. The size of a single cylindrical member 2, whether used singularly or with a plurality of other cylindrical members 2 in a patch formation 12 (FIG. 3), may be smaller or larger in diameter than the 4-inch diameter shown in FIG. 4. In certain examples, cylindrical members 2 of small diameter (less than two inches) are used in gentle water currents, while cylindrical members 2 of larger diameter (4 inches or greater) are used for stronger water currents that are frequently experienced in areas where tidal forces or rapids are common. Cylindrical members 2 are of varying porosity, wherein cylindrical members 2 with high porosity are less susceptible to movement in a water current, as more water is able to flow through the cylindrical member 2, and cylindrical members 2 with low to no porosity experience greater movement in response to water flow. In certain examples, the level of porosity varies with the size of cylindrical member and strength of the average current in the area. In one example, cylindrical members of smaller diameter in high current areas have a higher porosity to permit more water flow through the cylindrical member and avoid volatile movement of the cylindrical member. However, in another example, a cylindrical member with a larger diameter in the same current has a lower porosity because it takes increased current to move the larger cylindrical member. Thus, the diameter and porosity of a cylindrical member varies based on the intended environment in which the cylindrical member will be placed.

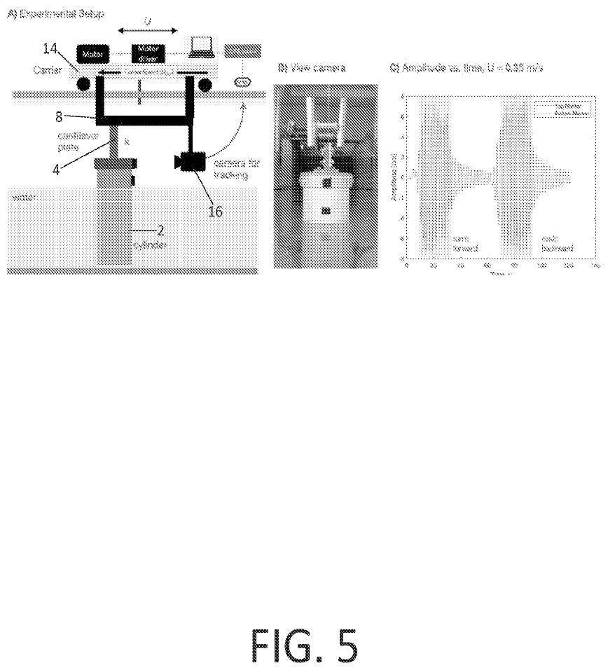

FIG. 5(a) shows an experimental setup of the cylindrical member 2 mounted in the towing carrier 14. In this exemplary embodiment, a single cylindrical member 2 is flexibly coupled to a mounting member 8 via an securing member 4. The cylindrical member 2 is submerged in water. A camera 16 is also coupled to the mounting member 8 to monitor the condition of the cylindrical member 2 in the water, as well as the cylindrical member's 2 level of movement in response to water current. The view from the camera 16 used in the experimental setup is depicted in FIG. 5(b). In the experimental setup of FIG. 5(a), a motorized carrier 14 moving on rails above the water tank 16 moves the cylindrical member 2 through the water to simulate the force of water against a cylindrical member 2 in a natural environment with water current. FIG. 5(c) shows a graph of amplitude of oscillation of the cylindrical member in cm vs. time in seconds for a carrier speed of 0.35 m/s. The gray regions show the areas with maximum amplitude. As carrier speed, or simulated water speed, increases in a forward run, amplitude, or oscillation of the cylindrical member 2, increases. As carrier speed decreases upon the carrier slowing down to a stop, amplitude decreases. In the backward run of the carrier, as carrier speed increases, amplitude increases again until the carrier slows to a stop, wherein the amplitude decreases.

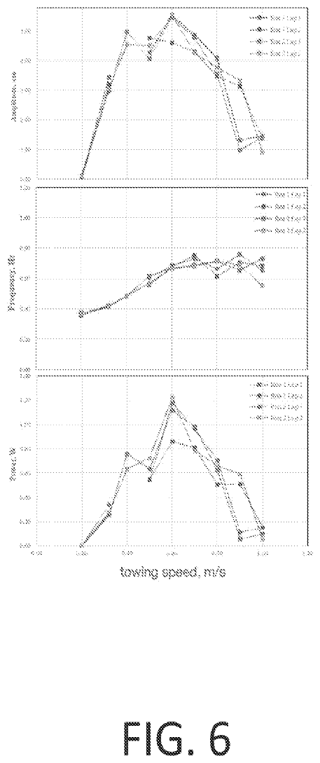

FIG. 6 shows three graphs of results of testing a single cylindrical member embodiment of the invention in multiple trials, wherein the graphs show: 1) amplitude in centimeters versus towing speed of the carrier in m/s, 2) frequency in Hz versus towing speed in m/s, and 3) power in W versus towing speed in m/s. The same experimental setup as shown in FIG. 5(a) was used. Two runs with the carrier were conducted, each including a first forward lap and a second backward lap. As shown in the graph address amplitude, the mode maximum amplitude of cylindrical member oscillation of approximately 5.8 cm for all runs was reached at a towing speed of approximately 0.6 m/s. In this example, towing speed simulates flow velocity in a natural environment. As shown on the graph measuring frequency, frequency of oscillation increases nearly proportionally with increased towing speeds until 0.6 m/s is reached for all runs. After 0.6 m/s, frequency increases or decreases for the individual runs and laps, but does not exceed the peak frequency of approximately 0.75 Hz reached at 0.6 m/s. Regarding the graph illustrating power, maximum power output was achieved for each lap at a towing speed of 0.6 m/s. Peak power output ranged from approximately 0.82 to 1.2 W. After 0.6 m/s, amplitude, frequency, and power had potential to decrease or peak inconsistently, illustrating that resonance within the exemplary system caused performance of the cylindrical member to decline after a certain optimal velocity. Thus, 0.6 m/s served as an optimal velocity for this exemplary system based on the cylindrical member's size and its surroundings, where amplitude and frequency were consistently the highest, and in turn, power output was the greatest. In other examples, differently sized cylindrical members are used based on the available flow velocity in a natural body of water.

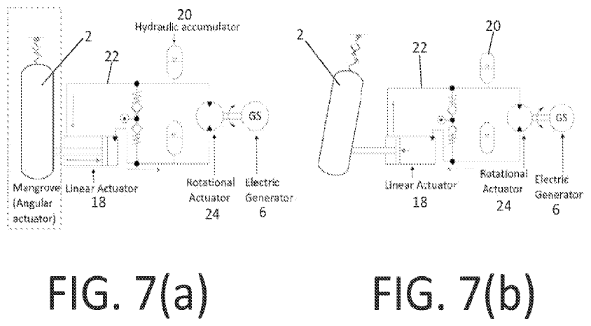

FIG. 7(a) shows an exemplary mangrove inspired system for energy harvesting with a hydraulic power conversion when the cylindrical member 2 is in a still state. The exemplary embodiment includes a singular cylindrical member 2 flexibly coupled to a linear actuator 18. The cylindrical member 2 is coupled to the linear actuator 18 with a securing member (FIG. 2(a)). The linear actuator 18 is located inside of a chamber 22, where the pressure of the chamber is regulated by a hydraulic accumulator 20. A rotational actuator 24, located inside the chamber, is coupled to a mechanical-to-electrical energy conversion member 6, in this case an electric generator. FIG. 7(b) shows the same exemplary system when the cylindrical member is oscillating in response to water movement and acting as an angular actuator. The oscillation of the cylindrical member 2 or patch of cylindrical members 2 move a linear actuator 18 that pressurizes a fluid in the chamber 22. The pressurized fluid is then used to move a rotational actuator 24 which is coupled to a mechanical-to-electrical energy conversion member 6 in the form of an electric generator, creating the mechanical energy to power the electric generator which converts the mechanical energy into electrical energy.

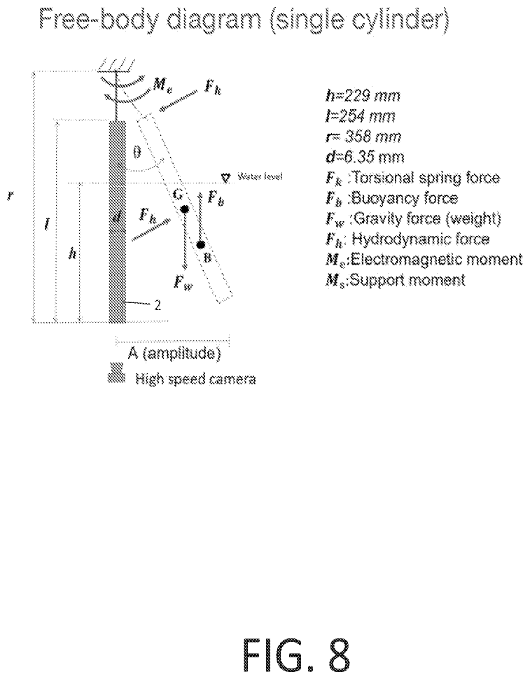

FIG. 8 shows a free-body diagram of an exemplary single-cylindrical member 2 model of the invention and the forces exerted upon the cylindrical member 2 while in use and oscillating. Fₖ represents the torsional spring force, F_{b} represents the buoyancy force, F_{w} represents the gravitational force in terms of weight, Fₕ represents the hydrodynamic force, or force of the current, and Mₑ represents the electromagnetic force of energy generated from the cylindrical member's movement. How far the cylindrical member 2 oscilates from the midline, represented by A in amplitude, is also depicted. The variable r depicts the length from the mounting member 8 to the end of the cylindrical member 2, the variable l depicts the length of the cylindrical member 2, and the variable h depicts the length from the water level to the lowest point of the cylindrical member 2.

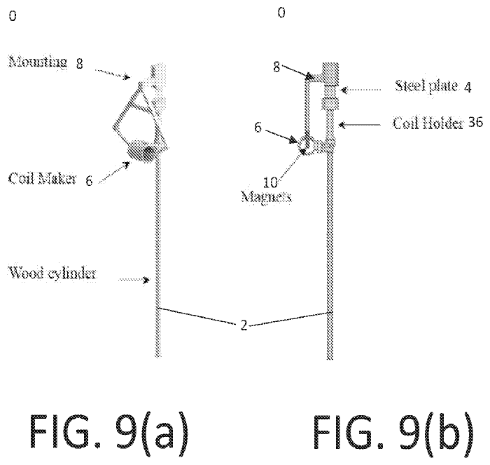

FIG. 9(a) shows an isometric view of a schematic of a single cylindrical member 2 embodiment of the invention 0. The cylindrical member 2 in this exemplary embodiment is made of wood material and is flexibly coupled to the mounting member 8 with a spring securing member 4. The mechanical-to-electrical energy conversion member 6 used in this example includes piezoelectric coils and magnets (FIG. 9(b)) used in tandem to generate electricity when the cylindrical member 2 oscillates in the water, acting as an angular actuator. It is notable that in certain examples the cylindrical member 2 is mounted from the top of the cylindrical member, flexibly coupled to a mounting member 8 on the water's surface. In other examples, the cylindrical member is mounted from the top, flexibly coupled to a mounting member beneath the water's surface. In other examples, the cylindrical member is mounted from the bottom, flexibly coupled to a mounting member anchored to the sediment floor—which includes one of an ocean floor, lakebed, or riverbed—wherein the top of the cylindrical member is still completely submerged beneath the water level. In additional examples, the cylindrical member is made of additional material including but not limited to plastic, foam, or metal. FIG. 9(b) shows a side view of a schematic of the same single cylindrical member 2 embodiment of the invention shown in FIG. 9(a). In this view, the securing member 4 is visible as well as the magnets 10 which work in tandem with the piezoelectric material to function as a mechanical-to-electrical energy conversion member 6. A coil holder 36 secures the coil of piezoelectric material in the mechanical-to-electrical energy conversion member 6.

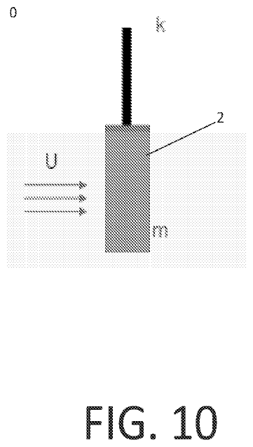

FIG. 10 shows another free-body diagram of an exemplary single-cylindrical member 2 embodiment of the invention. The variable k represents the stiffness of the spring. As water current, represented by the potential energy variable U, flows toward the mass of the cylindrical member 2 (m) the cylindrical member will oscillate with the waterflow. As the amplitude of the oscillation, or the distance from the cylindrical member's resting position, increases, more mechanical energy is produced.

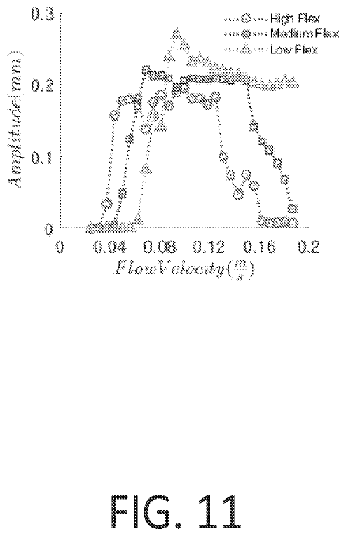

FIG. 11 shows a graph of the amplitude of oscillation for a single cylindrical member embodiment of the invention in mm versus flow velocity in m/s. Cylindrical members with high flexibility (represented by the line with circular designations), medium flexibility (represented by the line with square designations), and low flexibility (represented by the lines with triangular designations) were measured. Cylindrical members with lower flexibly were able to achieve greater average amplitudes than those with high flexibility. While greater flow results in greater oscillation, and therefore greater amplitudes, until 0.12 m/s, once optimal flow is reached, resonance within the exemplary system increased after 0.12 m/s and caused a smaller average amplitude. Thus, in this example, an optimal flow speed for the system ranged from 0.08-0.12 m/s without a decrease in peak value oscillation. Optimal flow speed varies depending on the size of the system and its surrounding environment.

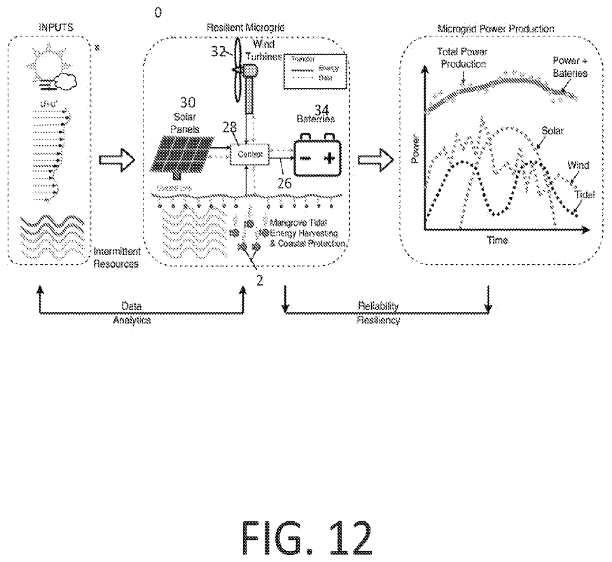

FIG. 12 shows a flow chart schematic of power generation using a plurality of the exemplary apparatus 0. In this flow chart, weather conditions, including wind, affect current. As water current comes into contact with a plurality of the apparatus, the cylindrical members 2 (FIG. 10) oscillate, generating mechanical energy, and in turn, electricity. An energy transfer system 26, represented by the solid black arrow, can transmit electricity generated by the apparatus via a power line or other line capable of transmitting power to a destination location, in this case, a control hub 28. In this particular example, the control hub 28 also receives energy input from other renewable energy sources, such as solar panels 30 and wind turbines 32. In this particular example, the control hub 28 is coupled to another energy transfer system 26 to transfer energy collected from the apparatus 0, wind turbines 32, and solar panels 30 to a destination location, in this case battery storage 34. Microgrid power production is additionally depicted in FIG. 12, with a graph representing the levels of power production produced by solar power, wind power, and tidal power with an exemplary apparatus of the invention. As is visible with the graph, the level of power generated from the apparatus oscillates over time, aligning with tidal patterns which would cause the cylindrical member 2 to oscillate.

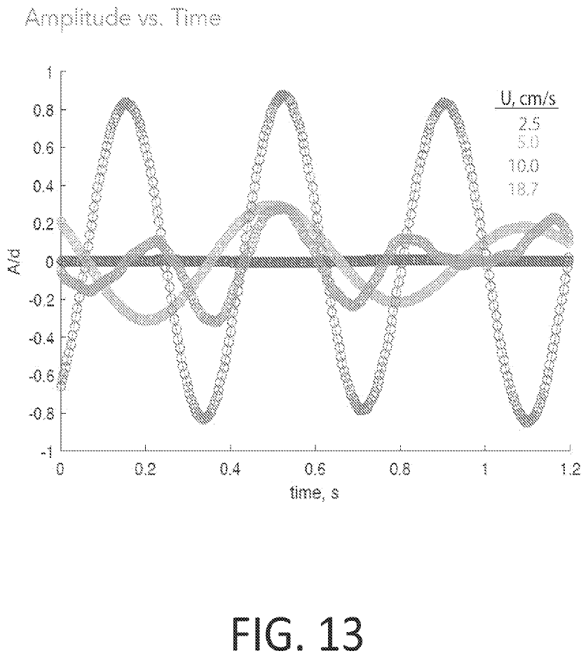

FIG. 13 shows a graph of amplitude of the wavelength of power generated by an exemplary embodiment of the invention versus time in seconds. Amplitude is measured in A/d. As is visible from the graph, three lines oscillate in amplitude over time, consistent with tidal currents. For examples used in the ocean, each wave increases the level of oscillation of a cylindrical member and, in turn, amplitude. When cylindrical members 2 return to their resting position, amplitude decreases. Each line represents the different velocities at which the exemplary system was tested. The central horizontal line (blue), located approximately at the midline, represents a cylindrical member tested at a flow of 2.5 cm/s, resulting in an oscillation of 0 A/d which is maintained throughout the entire duration of the test of the exemplary system. The two lines next-most central to the midline include the purple line representing a cylindrical member tested at a flow of 5.0 cm/s and the green line representing a cylindrical member tested at a flow of 18.7 cm/s. Both lines show oscillation at amplitudes approximately ranging from −0.3 to 0.3 A/d at peak. However, the purple line representing a flow velocity of 5.0 cm/s shows a longer wavelength than that of the green line representing a flow velocity of 18.7 cm/s. Finally, the line with the largest oscillation, the orange line, represents a cylindrical member tested at a flow of 10 cm/s, wherein the cylindrical member maintained an oscillation of approximately −0.8 to 0.8 A/d throughout the duration of the test. In this exemplary study, larger flow velocities correlated with greater oscillation of the cylindrical member until an optimal velocity for the exemplary system was reached (10 cm/s). At speeds higher than the optimal velocity, resonance within the system decreased the average peak potential oscillation.

### REFERENCES

[1] Global Climate Change. NASA, https://climate.nasa.gov/.
[2] Climate Change Indicators: Weather and Climate. United States Environmental Protection Agency, https://www.epa.gov/climate-indicators/weather-climate.
[3] United States Government (Apr. 1, 2021). Coastal Erosion, U.S. Climate Resilience Toolkit, https://toolkit.climate.gov/topics/coastal-flood-risk/coastal-erosion.
[4] Murdiyarso, D. et al. The potential of Indonesian mangrove forests for global climate change mitigation. Nat. Clim. Chang. 5, 1089-1092. https://doi.org/10.1038/s41467-018-04692-w2 (2015).
[5] Kazemi, A., Bocanegra Evans, H., Curet, O. & Castillo, L. On the role of mangrove root flexibility and porosity in sediment deposition and erosion control. Bull. Am. Phys. Soc. 63 (2018).

1. An apparatus for harvesting energy, the apparatus comprising: a) at least one cylindrical member; b) a mounting member; c) a securing member, wherein the securing member flexibly couples the cylindrical member to the mounting member; and d) a mechanical-to-electrical energy conversion member.

2. The apparatus of claim 1, wherein a plurality of the at least one cylindrical members are coupled to one another in a patch formation.

3. The apparatus of claim 1, wherein the mounting member comprises a corrosion resistant material.

4. The apparatus of claim 3, wherein the corrosion resistant material is selected from the group consisting of stainless steel, aluminum, copper, bronze, brass, galvanized steel, copper steel, alloy steel, polypropylene, polytetrafluorethylene (PTFE), polyvinyl chloride (PVC), and high-density polyethylene.

5. The apparatus of claim 1, wherein the securing member is selected from the group consisting of elastic, a linear spring, and a torsional spring.

6. The apparatus of claim 1, wherein the mechanical-to-electrical energy conversion member is selected from the group consisting of an electric generator, piezo-electric material, wind turbine, pelton wheel, and a hydraulic pump.

7. The apparatus of claim 1, wherein the mechanical-to-electrical energy conversion member includes magnets.

8. The apparatus of claim 1, wherein the mechanical-to-electrical energy conversion member is coupled to the mounting member.

9. The apparatus of claim 1, further comprising at least one actuator.

10. The apparatus of claim 9, wherein the at least one actuator is selected from the group consisting of an angular actuator, linear actuator, or rotational actuator.

11. The apparatus of claim 1, further comprising a hydraulic accumulator.

12. The apparatus of claim 1, further comprising an energy transfer system coupled to the mechanical-to-electrical energy conversion member.

13. The apparatus of claim 12, wherein the energy transfer system comprises a power line.

14. The apparatus of claim 1, further comprising a transmitter and a receiver, wherein the transmitter is coupled to the mounting member and the transmitter is located in a remote location.

15. A system of harvesting energy using the apparatus of claim 1, the system comprising: a) flexibly coupling at least one cylindrical member to a mounting member with a securing member; b) coupling a mechanical-to-electrical energy conversion member to the mounting member; c) placing the apparatus of the invention in a body of water with water current of a strength that is able to move the cylindrical member when the cylindrical member comes into contact with the water current; and d) generating electricity with the mechanical-to-electrical energy conversion member, wherein the movement of the cylindrical member in the water current provides necessary mechanical energy for the mechanical-to-electrical energy conversion member to generate electricity.

16. The system of claim 15, further comprising using a plurality of cylindrical members in a patch formation.

17. The system of claim 15, further comprising coupling at least one actuator to the apparatus, wherein a) the actuator is coupled to the cylindrical member and the mechanical-to-electrical energy conversion member, b) the actuator moves in response to the movement of the cylindrical member, and c) the actuator provides mechanical energy necessary to power the mechanical-to-electrical energy conversion member.

18. The system of claim 15, further comprising coupling an energy transfer system to the mechanical-to-electrical energy conversion member, wherein electricity generated from the mechanical-to-electrical energy conversion member is carried from the mechanical-to-electrical energy conversion member to a power usage destination.

19. The system of claim 15, further comprising transmitting water flow and electricity data from a transmitter coupled to the mounting member to a receiver located in a remote location.
